(19) United States
(12) Patent Application Publication
(10) Pub. No.: US 2012/0311081 A1
(43) Pub. Date: Dec. 6, 2012

(54) Management of Network-Based Digital Data Repository

(76) Inventors: Jeffrey L. Robbin, Los Altos, CA (US); Andrew Wadycki, Santa Clara, CA (US); Patrice Gautier, San Francisco, CA (US); Thomas Aisina, Mountain View, CA (US); Lucas C. Newman, San Francisco, CA (US); Sean B. Kelly, San Francisco, CA (US); Amandeep Jawa, San Francisco, CA (US); Payam Mirrashidi, San Francisco, CA (US); Max Muller, San Jose, CA (US); Ellis M. Verosub, San Carlos, CA (US); Arvind Shenoy, San Jose, CA (US); Olagappan Manickam, Cupertino, CA (US); Steve Saro Gedikian, Redwood City, CA (US); Michael Kuohao Chu, Cupertino, CA (US)

(21) Appl. No.: 13/488,336

(22) Filed: Jun. 4, 2012

Related U.S. Application Data
(60) Provisional application No. 61/493,321, filed on Jun. 3, 2011.

(51) Int. Cl. G06F 15/16

(52) U.S. Cl. 709/217

(57) ABSTRACT

Improved techniques and systems for storage, delivery and acquisition of digital assets are disclosed. The techniques and systems are suitable and useful for storing, delivering and accessing digital assets (e.g., media assets) that have been acquired from online stores. The techniques and systems are also suitable and useful for storing, delivering and accessing digital assets that have been acquired from other than from online stores. Regardless, the digital assets become accessible from a network-based digital data repository (e.g., cloud data storage) via electronic devices (e.g., user devices) and thus usable by the electronic devices. The digital assets can include media assets and/or non-media assets.

### CROSS-REFERENCE TO OTHER APPLICATION

This application claims priority to U.S. Provisional Patent Application No. 61/493,321, filed Jun. 3, 2011, entitled “MANAGEMENT OF NETWORK-BASED DIGITAL DATA REPOSITORY,” which is herein incorporated by reference.

### BACKGROUND OF THE INVENTION

Online stores and online shopping have become increasing more popular in recent years. Desktop and laptop computers have been used to purchase various goods and services from online stores. An online store may allow customers, via a network connection to the Internet, to browse, search and purchase various different items from the online store. Purchased items can be delivered by mail or make available for pickup at a store or another location.

Recently, digital assets (e.g., musical songs, movies, computer application programs) have become available for purchase from online stores. Moreover, digital assets have become available for delivery directly to the device used to purchase them. As such, today, a digital asset can be purchased from an online store by way of an electronic device (e.g., a desktop computer) from a residence and immediately delivered to the electronic device used to acquire the digital asset. In other words, after purchasing a digital asset from an online store via an electronic device, the digital asset can be “downloaded” by the electronic device for subsequent use thereon.

However, more recently, the number and variety of electronic devices with the ability to access online stores have dramatically increased. Today, a person may own and/or operate several electronic devices with the ability to access online stores, including a desktop computer, a laptop computer, a pad or tablet computer (e.g., iPad™), a smartphone, a media player, a gaming device, a television, and so on. In addition, an ever increasing number and types of digital assets are becoming available at online stores for various electronic devices, including, media, books, application programs, etc. As a result, management of delivery of digital assets to electronic devices can pose difficulties for users, especially those maintaining collections of various digital assets on several distinct electronic devices.

### SUMMARY

Improved techniques and systems for storage, delivery and acquisition of digital assets are disclosed. The techniques and systems are suitable and useful for storing, delivering and accessing digital assets (e.g., media assets) that have been acquired from online stores. The techniques and systems are also suitable and useful for storing, delivering and accessing digital assets that have been acquired from other than from online stores. Regardless, the digital assets become accessible from a network-based digital data repository (e.g., cloud data storage) via electronic devices (e.g., user devices) and thus usable by the electronic devices. The digital assets can include media assets and/or non-media assets.

The invention can be implemented in numerous ways, including as a method, system, device, or apparatus (including computer readable medium). Several embodiments of the invention are discussed below.

As a method for associating a client device to a remote data repository, one embodiment can, for example, include at least: receiving an activation request from the client device seeking to associate with the remote data repository, the remote data repository providing remote data storage; requesting hash values for artwork items on the client device; determining whether any of the requested hash values match hash values of existing artwork items already maintained in the remote data repository; and avoiding upload of those of the artwork items on the client device that have been determined to be already maintained in the remote data repository.

As a method for associating a client device to a remote data repository, another embodiment can, for example, include at least: receiving an activation request from the client device seeking to associate with the remote data repository, the remote data repository providing remote data storage; requesting hash values for artwork items on the client device; determining whether any of the requested hash values match hash values of existing artwork items already maintained in the remote data repository; and avoiding upload of those of the artwork items on the client device that have been determined to be already maintained in the remote data repository.

As a method for associating a client device to a remote data repository, still another embodiment can, for example, include at least: receiving an activation request from the client device seeking to associate with the remote data repository, the remote data repository providing remote data storage for a plurality of digital media assets; determining whether any local digital media assets stored on the client device are already present in the remote data repository, wherein the stored data for each of the local digital media assets includes at least a content item and an artwork item, and wherein the determining separately determines whether the content item and the artwork item for each of the local digital media assets are already present at the remote data repository; and requesting upload of data from the client device, the requested data to be uploaded including: (i) the one or more content items on the client device that are not determined to already be present in the remote data repository, and (ii) the one or more artwork items on the client device that are not determined to already be present in the remote data repository.

As a non-transitory computer readable medium including at least computer program code stored thereon for associating a client device to a remote data repository, one embodiment can, for example, include at least: computer program code for receiving an activation request from the client device seeking to associate with the remote data repository, the remote data repository providing remote data storage; computer program code for requesting hash values for artwork items on the client device; computer program code for determining whether any of the requested hash values match hash values of existing artwork items already maintained in the remote data repository; and computer program code for avoiding upload of those of the artwork items on the client device that have been determined to be already maintained in the remote data repository.

As a non-transitory computer readable medium including at least computer program code stored thereon for associating a client device to a remote data repository, another embodiment can, for example, include at least: computer program code for receiving an activation request from the client device seeking to associate with the remote data repository, the remote data repository providing remote data storage for a plurality of digital media assets; computer program code for determining whether any local digital media assets stored on the client device are already present in the remote data repository, wherein the stored data for each of the local digital media assets includes at least a content item and an artwork item, and wherein the computer program code for determining separately determines whether the content item and the artwork item for each of the local digital media assets are already present at the remote data repository; and computer program code for requesting upload of data from the client device, the requested data to be uploaded including: (i) the one or more content items on the client device that are not determined to already be present in the remote data repository, and (ii) the one or more artwork items on the client device that are not determined to already be present in the remote data repository.

As a system for providing a network-based repository accessible by client devices via a network, one embodiment can, for example, include at least cloud storage configured to store digital data for a plurality of account holders, and at least one cloud server operatively connected to the cloud storage. The cloud storage is accessible by authorized client devices via the network. The at least one cloud server can, for example, be configured to: (a) receive an activation request from a client device seeking to associate with the network-based repository, the networked-based repository providing remote data storage for a plurality of digital media assets; (b) determine whether any local digital media assets stored on the client device are already present in the network-based data repository, wherein the stored data for each of the local digital media assets includes at least a content item and an artwork item, and wherein the determining separately determines whether the content item and the artwork item for each of the local digital media assets are already present at the network-based repository; and (c) request upload of data from the client device, the requested data to be uploaded including: (i) the one or more content items on the client device that are not determined to already be present in the network-based repository, and (ii) the one or more artwork items on the client device that are not determined to already be present in the network-based repository.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a network-based data management system according to one embodiment.

FIGS. 2A-2B is a flow diagram of a cloud activation process according to one embodiment.

FIG. 3 is a flow diagram of a data matching process according to one embodiment.

FIGS. 4A-4B is a flow diagram of a data matching process according to one embodiment.

FIG. 5 illustrates a flow diagram of an artwork upload process according to one embodiment.

FIG. 6A is a flow diagram of an update notification process according to one embodiment.

FIG. 6B is a flow diagram of a device update process according to one embodiment.

FIG. 7 illustrates a cloud access management system according to one embodiment.

FIGS. 8A and 8B are flow diagrams of a cloud access process according to one embodiment.

### DETAILED DESCRIPTION OF EMBODIMENTS OF THE INVENTION

Improved techniques and systems for storage, delivery and acquisition of digital assets are disclosed. The techniques and systems are suitable and useful for storing, delivering and accessing digital assets (e.g., media assets) that have been acquired from online stores. The techniques and systems are also suitable and useful for storing, delivering and accessing digital assets that have been acquired from other than from online stores. Regardless, the digital assets become accessible from a network-based digital data repository (e.g., cloud data storage) via electronic devices (e.g., user devices) and thus usable by the electronic devices. The digital assets can include media assets and/or non-media assets.

One aspect of certain embodiments pertains to providing cloud data storage to participating client devices. Cloud data storage can be provided by a network-based repository that is capable of storing digital data for various users. As used herein, the network-based repository can be referred to as a remote data repository or a cloud data repository. The digital data being stored in the cloud data storage can be made available to respective users via a network, such as the Internet (or World Wide Web). Users can store in the cloud data storage various digital data, including digital assets that have been purchased online, digital assets acquired from other non-online means, and/or any other digital files of the user. Access to digital data via the cloud data storage can be restricted to authenticated users and to a limited number authorized devices (client device) per user. Hence, a given user can access the cloud data storage from any of his/her authorized client devices.

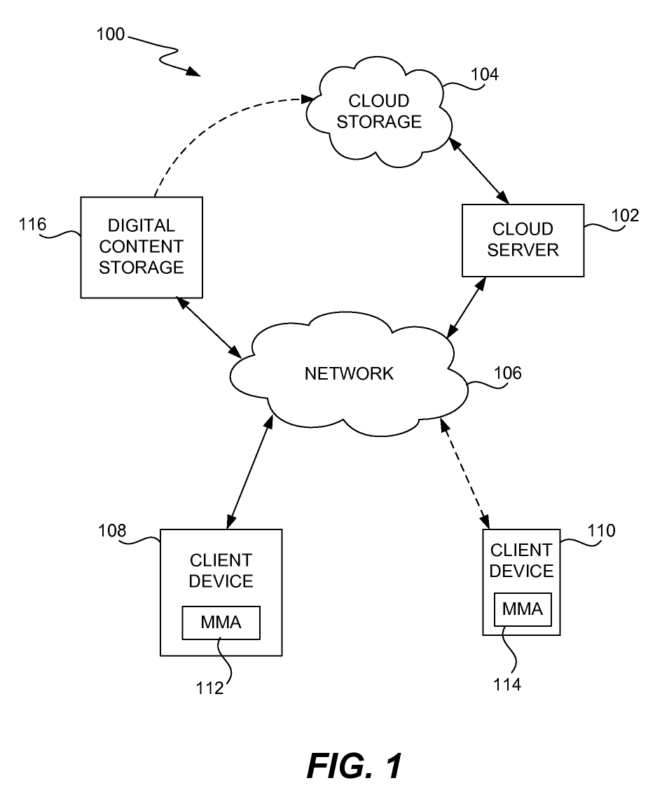

Exemplary embodiments of the invention are discussed below with reference to FIGS. 1-8B. However, those skilled in the art will readily appreciate that the detailed description given herein with respect to these figures is for explanatory purposes as the invention extends beyond these limited embodiments.

FIG. 1 is a block diagram of a network-based data management system 100 according to one embodiment. The network-based data management system 100 provides data management for a plurality of different users. The various users can operate one or more client devices to access data being stored remotely by the network-based data management system 100. The network-based data management system 100 can also manage synchronization of data between multiple client devices associated with a particular user.

The network-based data management system 100 includes a cloud server 102. The cloud server 102 is coupled to cloud storage 104. The cloud storage 104 provides a large amount of digital data storage that is coupled to a network 106. The cloud storage 106 can store digital data for a large number of different users. Although the cloud storage 104 is shared amongst a large number of different users, the digital data being stored for a given user can be accessible only by the given user. The cloud server 102 can serve to manage storage, access and distribution of data to and from the data storage by the cloud storage 104. The cloud storage 104 can also facilitate synchronization of data for users making use of the cloud storage 104. The cloud storage 104 is accessible by way of the cloud server 102 by client devices associated with users. For example, as illustrated in FIG. 1, client device 108 and client device 110 can be coupled to the network 106 so as to gain access to data stored in the cloud storage 104. The client devices 108 and 110 can represent electronic devices, such as computing devices. For example, the client device 108 can represent a computer, while the client device 110 can represent a mobile phone. Typically, the client devices 108 and 110 include an application program (or utility or operating system program) that facilitates access to the cloud server 102 by way of the network 106. The network 106 can consist of one or more wired or wireless networks. The client device 108 can, for example, connect to the network 106 by a wired connection, and the client device 110 can, for example, connect to the network 106 by a wireless connection.

Additionally, the client device 108 can include an application program, such as a media management application 112, that facilitates access, presentation and utilization of data stored either locally at the client device 108 or remotely at the cloud storage 104. Similarly, the client device 110 can include an application program, such as a media management application 114, that facilitates access, presentation and utilization of data stored either locally at the client device 110 or remotely at the cloud storage 104.

Still further, the network-based data management system 100 can include a digital content store 116. The digital content store 116 can facilitate electronic commerce to purchase, rent or otherwise acquire digital content. For example, the digital content store 116 can pertain to a digital media store that offers digital content, such as movies, songs, audio books, applications, and/or games for purchase, rental or utilization. Additionally, if a user of the client device 108 or 110 were to purchase a digital media item from the digital content store 116, the digital media item could be downloaded to the corresponding client device 108 or 110 as well as also provided to the cloud storage 104. Hence, the cloud storage 104 can store the purchased digital media item (or at least a link to the stored content) such that any of the user's client devices authorized for usage can access the cloud storage 104 associated with the user to gain access to the purchased digital media item. In this way, the purchase digital media item is directly added to the cloud storage 104 and thus does not need to be uploaded from the purchasing client device. Also, any of the user's other client devices that are authorized can also access (including downloading) the purchased digital media item from the cloud storage 104.

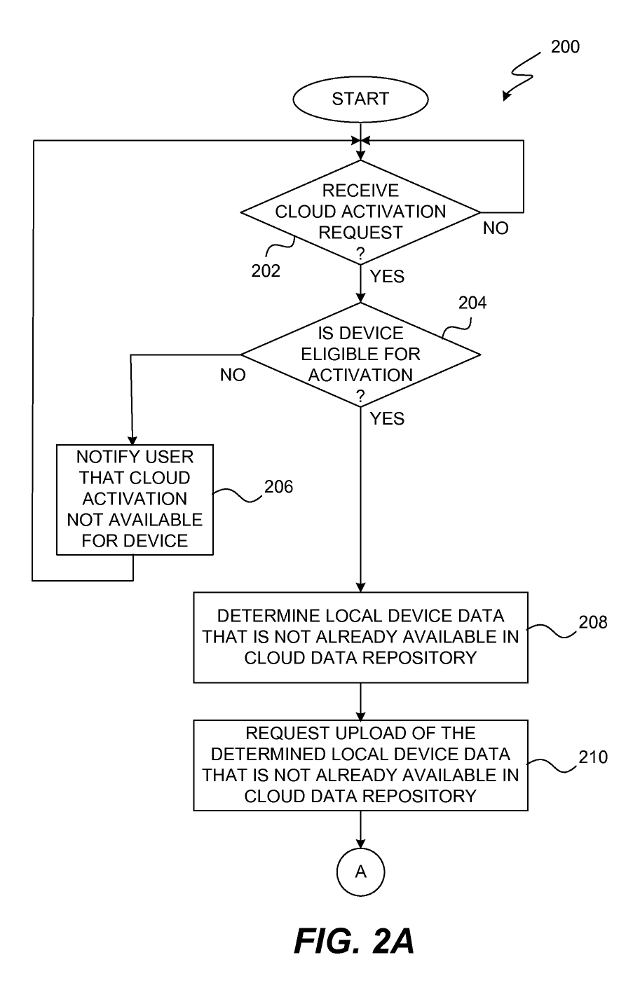

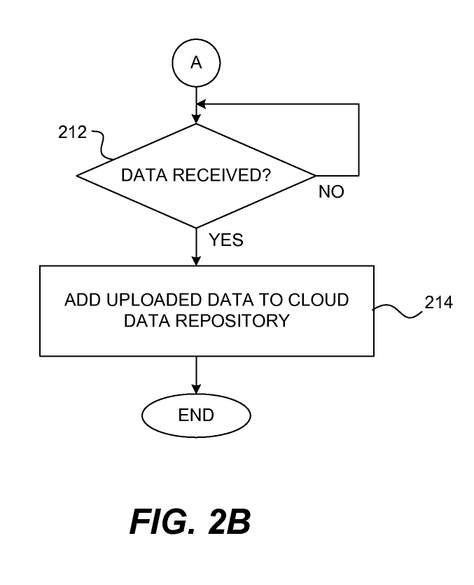

FIGS. 2A-2B is a flow diagram of a cloud activation process 200 according to one embodiment. The cloud activation process 200 can be performed by a computing device, such as the cloud server 102 illustrated in FIG. 1.

The cloud activation process 200 can begin with a decision 202 that determines whether a cloud activation request has been received from a client device. When the decision 202 determines that a cloud activation request has not yet been received, the cloud activation process 200 can await such a request. Once the decision 202 determines that a cloud activation request has been received from a particular client device, a decision 204 can determine whether the particular client device is eligible for activation. In one embodiment, cloud activation can be available to only a limited number of client devices associated with a given user. In general, eligibility can be established by predetermined rules or policies that govern the number, type and/or timing for activation eligibility.

When the decision 204 determines that the particular client device is not eligible for activation, the user can be notified 206 that cloud activation is not available for the particular client device. Following the notification 206, the cloud activation process 200 can return to repeat the decision 202 and subsequent blocks so the cloud activation can be continuously monitored if so desired.

On the other hand, when the decision 204 determines that the particular client device is eligible for activation, additional processing can be performed to upload any local data from the particular client device to cloud storage (e.g., cloud storage 104) to a cloud data repository (remote data repository). However, for efficient use of network bandwidth and storage as well as for energy conservation, processing can be performed to upload only that portion of the local data that is not already available in the cloud storage. In particular, when the decision 204 determines that the particular client device is eligible for activation, the cloud activation process 200 can determine 208 local device data that is not already available in the cloud storage.

Next, upload of the determined local device data that is not already available in the cloud data repository can be requested 210. A decision 212 can determine whether the requested local device data has been received. Here, the cloud activation process 200 can determine whether the data that has been requested to be uploaded from the particular client device has been received. When the decision 212 determines that such data has not yet been received, the cloud activation process 200 can await such data. Once the decision 212 determines that the requested data to be uploaded has been received, the uploaded data can be added 214 to the cloud data repository. After the uploaded data has been added 214 to the cloud data repository, the cloud activation process 200 can end. Following conclusion of the cloud activation process 200, the particular client device has in effect been activated for use of the cloud storage, whereby the local device data from the client device is rendered available from the cloud data repository and thus can be accessed by other client devices of the same user.

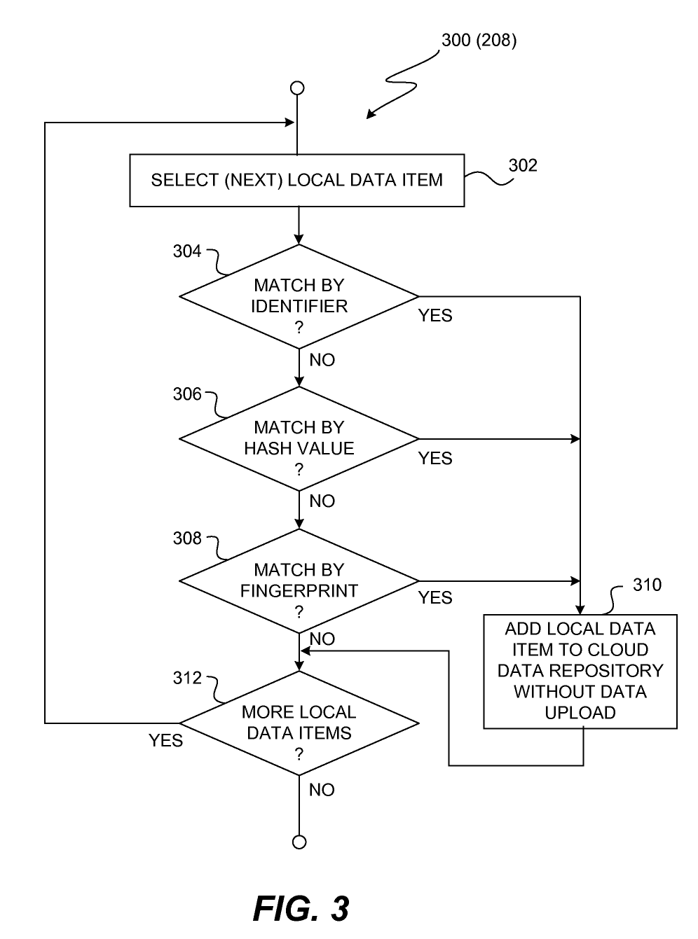

FIG. 3 is a flow diagram of a data matching process 300 according to one embodiment. The data matching process 300 can, for example, represent processing performed by the block 208 illustrated in FIG. 2A.

The data matching process 300 can select 302 a local data item from local device data that is stored on the particular client device being activated. A decision 304 can then determine whether the selected local data item can be matched through use of one or more identifiers. Depending upon where the selected local data item was acquired from, the selected local data item may include one or more identifiers. Through use of these one or more identifiers, the cloud server 102 can evaluate whether a cloud data repository (e.g., cloud storage 104) already stores the same exact data item (or perhaps same data item but of greater quality). For example, if the local data item was purchased and downloaded from an online store (e.g., digital content store 116), then the local data item can include or associate to one or more identifiers that may be known to the cloud server 102, particularly if the cloud server 102 is affiliated with the online store or if a global or standard identifier is used. The identifiers are typically numeric or alphanumeric values that are centrally assigned by a computing device, such as the cloud server 102. In one embodiment, the identifiers are associated with a user cloud storage space. In another embodiment, the identifiers are globally assigned across multiple or all users.

If the selected local data item is not able to be matched by way of one or more identifiers, a decision 306 can determine whether the selected local data item can be matched by a hash value. Here, the selected local data item can be represented as a hash value that can be compared by the cloud server 102 with hash values of data items already stored at the cloud data repository.

If the selected local data item is not able to be matched by way of its hash value, a decision 308 can determine whether the selected local data item can be matched by a fingerprint. The fingerprint can be created by a predetermined algorithm and can represent a presumptively unique electronic fingerprint of the data item. In this case, the selected local data item can be processed at the client device to provide a fingerprint. The fingerprint can then be provided to the cloud server 102 which can evaluate whether the fingerprint provided by the client device matches any fingerprints for data items already stored at the cloud data repository.

If the selected local data item is able to be matched by any of the one or more identifiers, the hash value or the fingerprint, the selected local data item can be added 310 to the cloud data repository without any uploaded data (i.e., without any content upload). In this case, since the selected local data item is able to be matched with an existing data item already resident in the cloud data repository, the uploading of such data item is not necessary as the local data item can be associated with the data item already existing in the cloud data repository. Consequently, network resources and energy that would otherwise be consumed to transmit and store the data item can be conserved.

When the decision 308 determines that the selected local data item is not able to be matched by fingerprint, as well as following the block 310 when matching has occurred, a decision 312 can determine whether there are more local data items to be processed. When the decision 312 determines that there are more local data items to be processed, the data matching process 300 can return to repeat the block 302 so that another local data item can be selected and similarly processed. When the decision 312 determines that there are no more local data items to be processed, the data matching process 300 can end.

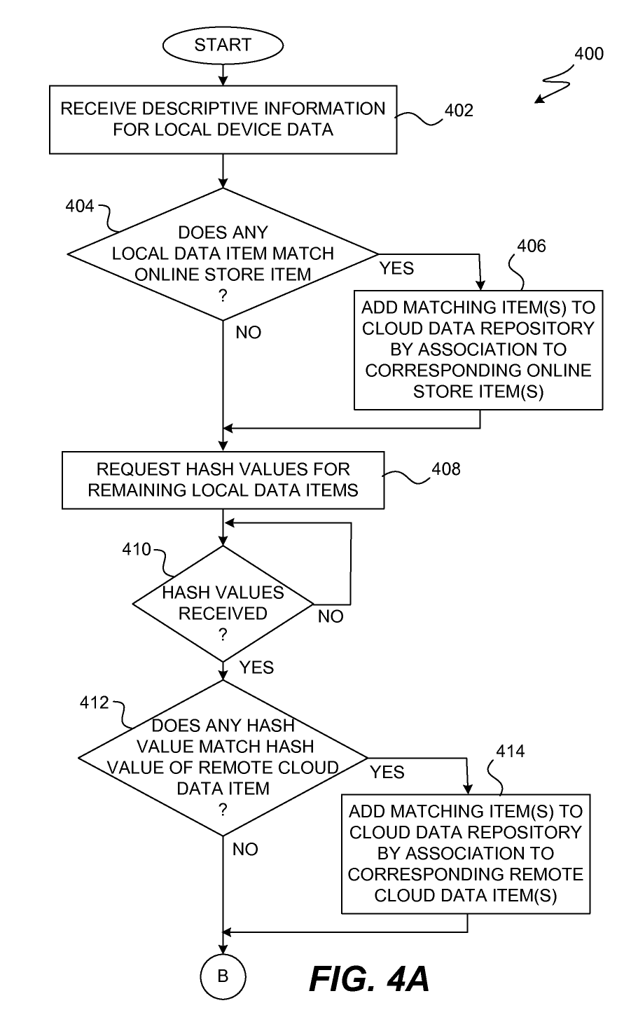

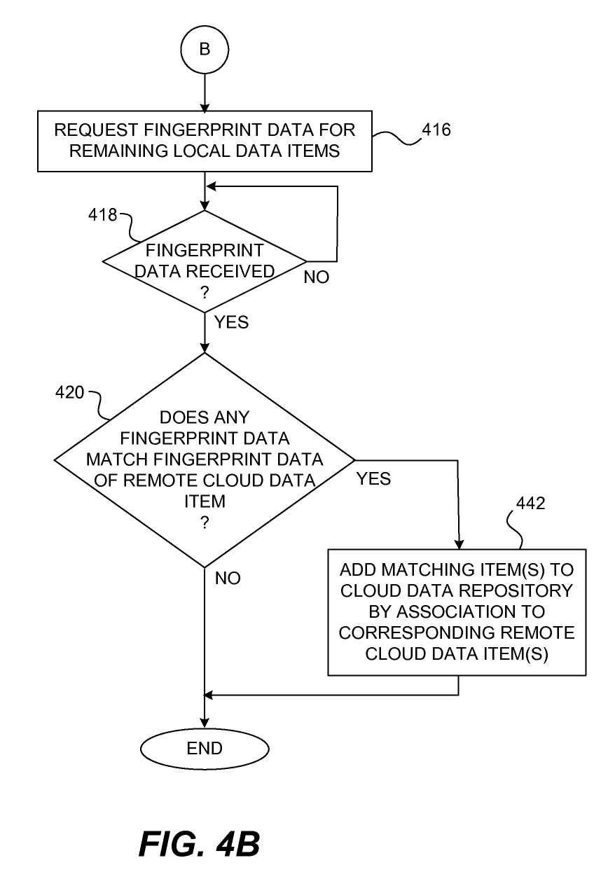

FIGS. 4A-4B is a flow diagram of a data matching process 400 according to one embodiment. The data matching process 400 can, for example, represent a more detailed process than the data matching process 300 illustrated in FIG. 3.

The data matching process 400 can receive 402 descriptive information for local device data. The descriptive information serves to describe characteristics or attributes for the local device data. As an example, the descriptive information can include metadata well as one or more identifiers for the various device data items within the local device data. The metadata can describe the corresponding data items. For example, for a digital media asset, the metadata can specify attributes such as title, artist, genre, user-rating, etc. The metadata might also specify characteristics such as bit rate, encoding, duration, etc. The one or more identifiers are typically assigned such that they are unique for a given digital item. For example, an online store (e.g., digital content store 116) can assign unique identifiers to each of its digital online store items that are offered to users for acquisition.

Next, a decision 404 can determine whether any of the local data items match with an online store item. Here, the one or more identifiers provided in the descriptive information can be utilized to compare to identifiers associated with online store items available at the online store. When the decision 404 determines that there is a match, the match indicates that the local data item was acquired from the online store and thus has a matching identifier. In this case, the one or more matched items can be added 406 to the cloud data repository by association to one or more corresponding online store items.

Alternatively, when the decision 404 determines that none of local data items match the online store items, or following the block 406 in the case in which there are one or more matches, hash values for the remaining local data items can be requested 408. Here, the computing device performing the data matching process 400 (e.g., cloud server 102) can request the hash values from the particular client device being activated. A decision 410 can then determine whether the requested hash values have been received. When the decision 410 determines that the requested hash values have not yet been received, the data matching process 400 can await the requested hash values.

Once the decision 410 determines that the requested hash values have been received, a decision 412 can determine whether any of the hash values match any hash values of remote cloud data items. Here, the hash values pertain to a digital identifier that is computed from the electronic file containing or associated with a given local data item. The hash value can thus be used to identify identical electronic files. As an example, the hash value utilized can result from using an MD5 hash algorithm. When the decision 412 determines that one or more hash values for local data items match one or more hash values for remote cloud data items, the one or more corresponding local data items can be thus identified as each matching a remote cloud data item already provided in the cloud storage. Hence, in this case, the one or more matching items can be added 414 to the cloud data repository by association to one or more corresponding remote cloud data items.

Moreover, following the decision 412 when their are no hash values that match hash values of remote cloud data items, or following the block 414 when there are matching items, the data matching process 400 can request fingerprint data for any of the remaining local data items. A decision 418 can then determine whether the requested fingerprint data has been received. When the decision 418 determines that the requested fingerprint data has not been received, the data matching process 400 can await such data.

Once the decision 418 determines that the requested fingerprint data has been received, a decision 420 can determine whether any of the fingerprint data for the remaining local data items matches fingerprint data of remote cloud data items already resident in the cloud data repository. When the decision 420 determines that the fingerprint data for one or more of the remaining local data items does match fingerprint data of one or more corresponding remote cloud data items, the one or more matched items can be added 442 to the cloud data repository by association to corresponding remote cloud data items. Following the decision 420 when there are no fingerprint matches, or following the block 442 when there are fingerprint matches, the data matching process 400 can end.

In the embodiment of the data matching process 400 illustrated in FIGS. 4A and 4B, there are three different avenues to provide matching with respect to data already available in the cloud data repository. The first matching test uses identifiers (e.g., assigned identifiers), the second matching test uses hash values, and the third matching test utilizes fingerprints. If matches are identified using any of these series of matching tests, the corresponding data items from the local device data need not be copied to the cloud data repository because such data is already resident in the cloud data repository. If one or more of the local data items within the local device data are not able to be matched in any way, the local data items can be uploaded to the cloud data repository (e.g., FIG. 2B, block 214).

It should also be noted that the data matching process 400 assumes that all three stages of matching are generally utilized. However, it should be recognized that if all of the local data items have already been matched, there is no need for additional matching processing. In other words, if all of the local data items have been matched through the use of matching with online store items or hash values of cloud data items, then there would be no need to request and evaluate fingerprint data to identify matches.

The data matching process 400 illustrated in FIGS. 4A and 4B is, for example, well suited for matching local device data, such as media content. Examples of media content include: songs, videos, audiobooks, music videos, podcasts. However, in one embodiment, in the case where the media content includes associated artwork, the matching and upload processing for the artwork can be performed separately. Since users of media content (e.g., songs) can be permitted to customize the associated artwork, the artwork for a given media content can be user dependent. As such, separately processing artwork for media content can maintain the ability to support user customization of artwork for media content.

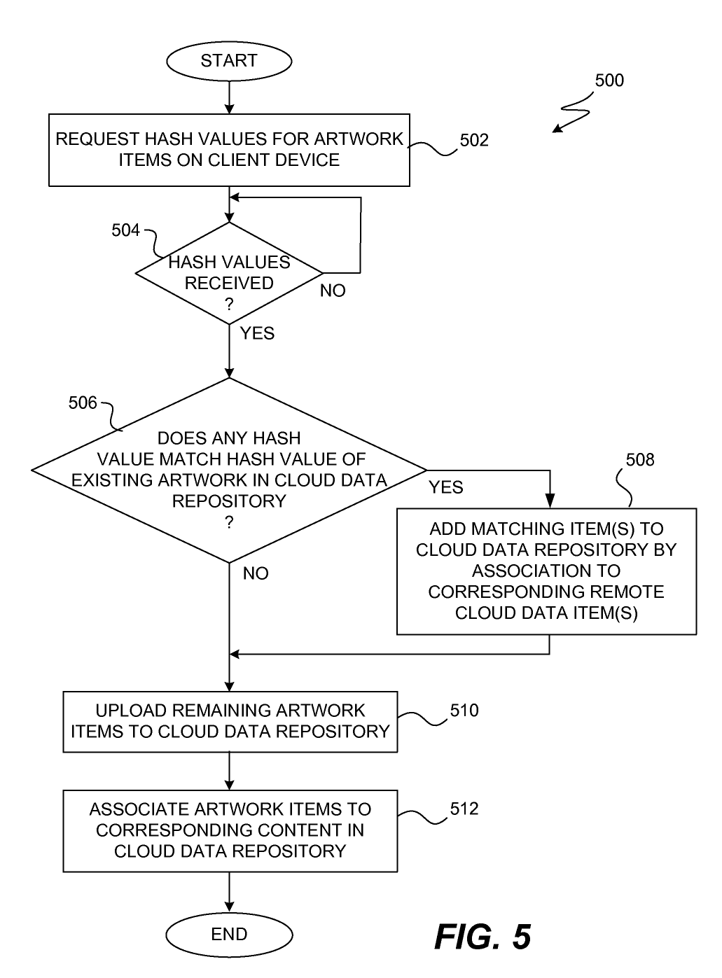

FIG. 5 illustrates a flow diagram of an artwork upload process 500 according to one embodiment. The artwork upload process 500 can operate to separately upload artwork that is utilized by media content provided on the particular client device being activated. The artwork upload process 500 is able to reduce the amount of data that needs to be uploaded to a cloud data repository by first checking if the artwork is already present at the cloud data repository.

The artwork upload process 500 can request 502 hash values for artwork items on the client device. Typically, the client device has a plurality of media content files and their associated artwork items stored thereon. The hash values for the artwork items can be computed at client device and then provided to a remote server computer, such as the cloud server 102, that can perform the artwork upload process 500. After the hash values have been requested 502, a decision 504 can determine whether the requested hash values have been received. When the decision 504 determines that the hash values have not been received, the artwork upload process 500 can await the receipt of the requested hash values.

Once the decision 504 determines that the hash values for the artwork items have been received, a decision 506 can determine whether any of the hash values for the artwork items on the client device match any of the hash values for existing artwork already provided in the cloud data repository. When the decision 506 determines that there are one or more matching hash values, the matching artwork items (associated with the matching hash values) can be added 508 to the cloud data repository by association to corresponding existing artwork.

On the other hand, when the decision 506 determines that there are no matching hash values, the artwork items are uploaded 510 to the cloud data repository. Also, following the block 508, any remaining artwork items can be uploaded 510 to the cloud data repository. The remaining artwork items are those artwork items on the client device that have not been found to match existing artwork in the cloud data repository. It should be noted that when all of the hash values for the artwork items on the client device match existing artwork in the cloud data repository, there is no need to upload 510 any artwork items from the client device to the cloud data repository. Following the upload of none, some or all of the artwork items from the client device to the cloud data repository, the artwork items that have been uploaded 510 can be associated 512 to corresponding content in the cloud data repository. After the artwork items are associated 512 to corresponding content in the cloud data repository, the artwork upload process 500 can end.

Another aspect of certain embodiments is that matching of local data items to cloud data items can also facilitate upgrading user data to higher quality data item. As an example, if a local data item at a client device of a user is determined to match an existing cloud data item, there is no need to upload the local data item (or at least its content) to the cloud data repository. Instead, the same data item already resident in the cloud data repository can be referenced and then utilized by the user. For example, the user can be permitted to download or stream the cloud data item to any of a plurality of authorized client devices associated with the user. Furthermore, in some cases, the existing cloud data item that is deemed to match the local data item has a greater quality (e.g., higher encoding, high definition, greater resolution, etc.). In such cases, the cloud data in the cloud data repository is associated with the user so that the user can utilize the existing cloud item with the greater quality. In effect, the user's data can be upgraded to a greater quality when participating in cloud storage.

Although FIGS. 3-4B describe hierarchical levels of matching for robust matching, in some embodiments, less robust matching can be utilized. In one embodiment, matching can be performed by comparison of metadata. For example, if a client device has existing local device data (at time of cloud activation), the metadata for the local device data from the client device can be compared with known metadata at the cloud server. If the metadata matches, or at least matches a predetermined set of attributes (e.g., title, artist, album, etc.), the corresponding digital media asset can be considered to be the same.

For example, a client device, such as a portable media player or mobile phone, which has limited processing capacity (e.g., as compared to a desktop or notebook computer) may utilize the less robust matching to determine whether local digital media assets can be retained on the client device. For instance, if a cloud repository system is configured to have cloud storage be the master storage, then so long as the local digital media assets are deemed a match (e.g., using a less robust metadata match), then the local digital media assets can be retained on the client device (and also not uploaded to the server). However, to permit the client device to download the same or equivalent digital media asset from a cloud data repository (or a media store), the server would typically require robust matching to insure that the digital media assets match. The robust matching can reliably ensure that the client device (or its user) has acquired rights to a given digital media asset. Hence, if the digital media asset reliably matches a digital media asset at the cloud server, then the cloud server adds/authorizes the inclusion of the digital media asset at the cloud server for inclusion in the cloud storage available to the user. In addition, matching can permit the client device to acquire a higher quality version of the same digital media asset if the cloud repository, and thus the media store, stores the higher quality version (e.g., 256 Kbps ACC).

In one embodiment, for a given digital media asset having metadata, artwork and media content as separate components, each of such components can be separately stored at the cloud data repository. In one embodiment, the components for artwork and media content are centrally stored at the cloud data repository and then associated with those users that are authorized for its use. Hence, a central copy of media content for a digital media asset can be associated with numerous users, and thus each of the associated users are able to download or stream such data. Also, a central copy of artwork for a digital media asset can be associated with numerous users, and thus each of the associated users are able to download or stream such data. The ability to share media content and artwork stored at the cloud data repository provides for efficient centralized data storage. As for metadata, different users may customize the metadata, but many users will simply use the standard (or default) metadata. Hence, in one embodiment, the metadata for each of the digital media assets can be maintained separately for each user or user account. However, in another embodiment, the metadata, or components thereof, can be stored at the cloud data repository such that a single copy of the metadata, or components thereof, can be associated with numerous users. In some cases it will be known that the metadata from the client device is incomplete and that the metadata known to the server is more complete. As a result, the server can optionally update or upgrade the metadata in the cloud repository to be utilized for the client device (and other client devices of the same user account).

Another aspect of certain embodiments is that matching can be performed directly with data items resident on a compact disc (CD). A user can obtain a CD that includes one or more digital media assets, such as audio tracks pertaining to songs. Conventionally, a user would insert the CD into a computer operating a media management application, and then initiate an import operation to import all of the audio tracks from the CD into electronic storage of the client device (e.g., computer) for management by the media management application. This importing, also known as ripping, can be rather time intensive. Furthermore, the addition of these audio tracks from the CD to the local data items of the client device would still not provide them to the cloud data repository. Hence, if the client device is participating in the cloud storage, the audio tracks within the local data storage would then have to be further processed to perform either matching with existing resources already at the cloud storage or uploading to the cloud storage. Accordingly, the media management application can avoid the need to import or rip the CD to acquire the audio tracks from the CD. Instead, the client device (e.g., the media management application) can acquire identifying information from the CD and then transmit this information to the cloud server. The cloud server can then operate to perform a matching process to determine whether the cloud storage already has the audio tracks from the CD. If so, the cloud server can make the audio tracks part of the user's cloud storage by simply associating with the pre-existing audio tracks. Advantageously, such processing can avoid the need for any importing or ripping at the client device, while also avoiding the need to perform hashing and/or fingerprinting operations and the like to perform other types of matching checks. In other words, similar to the decision 304 illustrated in FIG. 3, a data matching process with respect to a CD can utilize an identifier associated with the CD. The identifier can be a unique numeric identifier for the CD or the identifier can include characteristics of the data items within the CD. Once the cloud server matches the CD, the audio tracks on the CD can be added to the user's cloud storage (without uploading content data) and can also thereafter be accessed by any of the user's client devices.

Another aspect of certain embodiments can provide synchronization amongst a users plurality of client devices as well as synchronization of the user's content resident at a cloud data repository. The synchronization operates to synchronize data between the different client devices and the cloud data repository. The implementation, according to one embodiment, can utilize notifications, such as push notifications or pull notifications, to inform other devices of changes or updates that have occurred with respect to its data. For example, if new data has been added to the client device, an update notification process can operate to notify the appropriate cloud server (e.g., cloud server 102) of the specific update that has occurred at client device. The cloud server can then in turn cause the cloud data repository to be similarly updated. The cloud server can also operate to notify other client devices associated with the same registered user of the update.

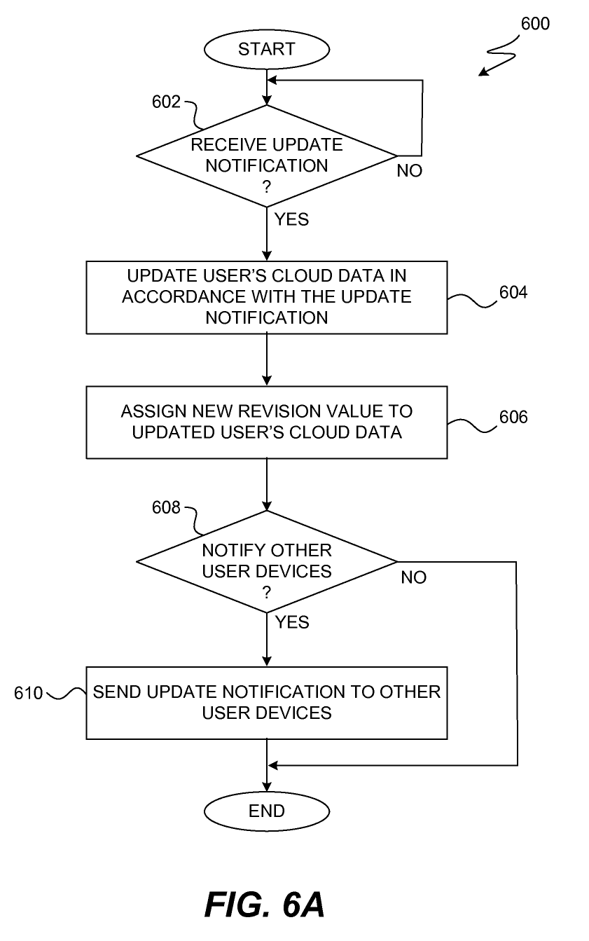

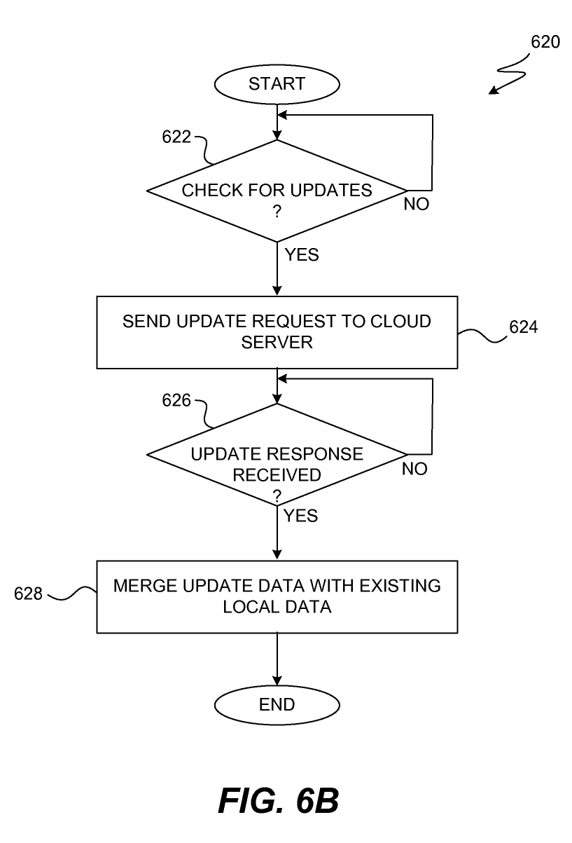

FIG. 6A is a flow diagram of an update notification process 600 according to one embodiment. The update notification process 600 is, for example, processing performed by a server computer, such as a cloud server (e.g., cloud server 102).

The update notification process 600 can begin with a decision 602 that determines whether an update notification has been received. Here, an update notification can be sent by a client device and received by the cloud server. When the decision 602 determines that an update notification has not been received, the update notification process 600 can await such a notification. Once the decision 602 determines that an update notification has been received, the update identified in the update notification can be used to update the cloud data repository associated with the user. In particular, the user's cloud data can be updated 604 in accordance with the update notification. Also, a new revision value can be assigned 606 to the updated user's cloud data. For example, the user's cloud data can be referred to as a library, and each time the library is updated (e.g., by a notification or otherwise), it can be assigned a new version value.

Next, a decision 608 can determine whether to notify other user devices. Here, assuming that the user of the client device (e.g., client device that initiated the notification) has other user devices, the decision 608 can determine whether the other user devices (e.g., client devices) should be notified of the update. When the decision 608 determines that one or more other user devices are to be notified, then an update notification can be sent 610 to each of the other one or more user devices. Alternatively, when the decision 608 determines that no other user devices are to be notified, the block 610 can be bypassed. Following the block 610, or its being bypassed, the update notification process 600 can end.

FIG. 6B is a flow diagram of a device update process 620 according to one embodiment. The device update process 620 is, for example, performed by a client device.

The device update process 620 can begin with a decision 622 that determines whether to check for updates. As an example, the client device performing the device update process 620 can check for updates on a periodic basis, on login to the cloud server, on user-initiated request, or for any other configured reason. When the decision 622 determines that there is no current need to check for updates, the decision 622 causes the device update process 622 to await the need to check for an update. On the other hand, when the decision 622 determines that an update check should be performed, an update request can be sent 624 to the cloud server. Next, a decision 626 can determine whether an update response has been received from the cloud server. Here, the update request can ask the cloud server if there is any update for the client device given the current status of the local device data. As an example, the update request can provide the cloud server the specific version of the library (local device data) resident on the client device. The cloud server can then identify the specific updates that are required to bring the specific version of the library resident on the client device to its most current state. Hence, the update response can include the necessary information so that the client device can bring itself up to date. In this regard, when the decision 626 determines that an update response has not yet been received, the device update process 620 can await such a response. However, once the decision 626 determines that an update response has been received, update data provided in or derived from the update response can be merged 628 with existing local data (local device data) at the client device. After the update data has been merged 628 with the existing local data such that the local data is updated, the device update process 620 can end.

Another aspect of certain embodiments is that a graphical user interface can be presented on a client device. The graphical user interface can allow a user of the client device to interact with cloud storage (e.g., cloud data repository or remote data repository) via a cloud server. In one embodiment, the graphical user interface can present a view of digital assets within the user's cloud storage. For example, as presented on a display of the client device, the view can be an integrated view in which those of the digital assets available local in local storage of the client device are visually distinguish from those other digital assets that are available from the user's cloud storage but whose content is not stored locally. Still further, for those other digital assets that are available from the user's cloud storage, the graphical user interface can provide a user-selectable control to initiate a request to download one or more digital assets from the user's cloud storage to the local storage of the client device. The graphical user interface can also enable a user to delete a digital asset that is stored locally at the client device (with or without also deleting from the user's cloud storage).

One aspect of certain embodiments pertains to managing access to cloud data storage. The cloud data storage can be provided by a cloud data repository that is capable of storing digital data for various users. The digital data being stored in the cloud data storage can be made available to respective users via a network, such as the Internet (or World Wide Web). Users can store digital assets that have been purchased online, digital assets acquired from other non-online means, or any other digital files of the user. Access to digital data via the cloud data storage can be restricted to authenticated users and to a limited number authorized devices per user.

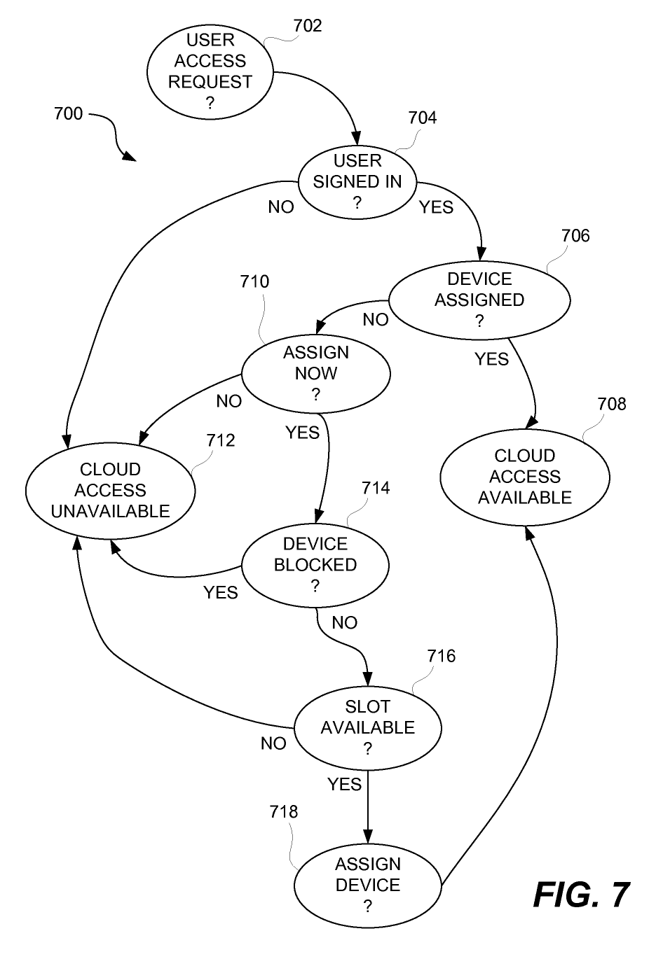

FIG. 7 illustrates a cloud access management system 700 according to one embodiment. The cloud access management system 700 determines whether a particular user is able to access a cloud data repository through use of a particular client device. In doing so, the cloud access management system 700 can utilize various different states in managing whether or not users are permitted access to the cloud data repository.

The cloud access management system 700 can initially receive a request 702 by a user to access the cloud data repository. Since the cloud data repository supports cloud data storage for many different users, a given user is allocated their own data storage in the cloud data repository. Also, the request 702 to access the cloud data repository is initiated by the user via a particular client device. To facilitate access and interaction with the cloud data repository, a data management application can operate on the particular client device being utilized by the user. The user is typically a registered user for the data management application and can thus “sign in” so that the data management application recognizes the user. For example, a user name and password can be provided by the user to “sign in” to the data management application. In one embodiment, the data management application is a media management application.

At state 704, the cloud access management system 700 can evaluate whether the user has signed in to the data management application. If the user has signed in, the cloud access management system 700 can progress to state 706 where it can be determined whether the particular client device being utilized by the user has been assigned to the user. In this embodiment, a given user is permitted to utilize the cloud data repository from only at most a predetermined limited number of client devices (e.g., electronic devices). Hence, at state 706, it is determined whether the particular client device being utilized by the user has been assigned to the user by the cloud access management system 700.

When, at state 706, determines that the particular device has been assigned to the user, then the cloud access management system 700 can proceed to state 708 were cloud access is available to the user through use of the particular client device. On the other hand, at state 706, when it is determined that the particular client device being utilized by the user has not been assigned to the user, the cloud access management system 700 can proceed to state 710 where the user is possibly able to establish assignment of the particular client device to the user.

At state 710, if the user does not desire to assign the particular client device to the user at this time, the cloud access management system 700 proceeds to state 712 and thus concludes that cloud access is unavailable to the user via the particular client device. In other words, the user is not permitted to access the cloud data repository through use of the particular client device. Additionally, the cloud access management system 700 can also proceed from state 704 directly to state 712 if the user has not signed in to the data management application, and thus access to the cloud data repository is also denied in this situation.

On the other hand, at state 710, if the user desires to assign the particular device to the user so that access to the cloud data repository can be permitted by way of the particular client device, the cloud access management system 700 can proceed to step 714. At step 714, it can be determined whether the particular client device is currently blocked from being assigned. Here, in one embodiment, client devices can be restricted, or blocked, from being assigned if they have been previously assigned within a predetermined period of time. For example, a 90 day blocking period can be established for all client devices so that they can only be assigned once within a 90 day period. In any case, if the particular client device is blocked, the cloud access management system 700 proceeds to state 712 where cloud access to the cloud data repository is unavailable to the user by way of the particular device.

Alternatively, if it is determined at step 714 that the particular device is not blocked, the cloud access management system 700 can proceed to state 716 where it can be determined whether a slot is available for the particular client device. Here, it should be understood that a given user has a predetermined limited number of available slots that can be assigned to client devices. At state 716, it can be determined whether there is an available slot that can be assigned to the particular client device now being utilized by the user. If it is determined at state 716 that there is no available slot, the cloud access management system 700 can proceed to state 712 and cloud access to the cloud data repository is unavailable. On the other hand, if it is determined at state 716 that there is an available slot, the cloud access management system 700 can proceed to state 718 where the particular client device can be assigned to the available slot. After the particular client device has been assigned to the available slot, the cloud access management system 700 can proceed to state 708 where cloud access to the cloud data repository available is permitted by the user using the particular client device.

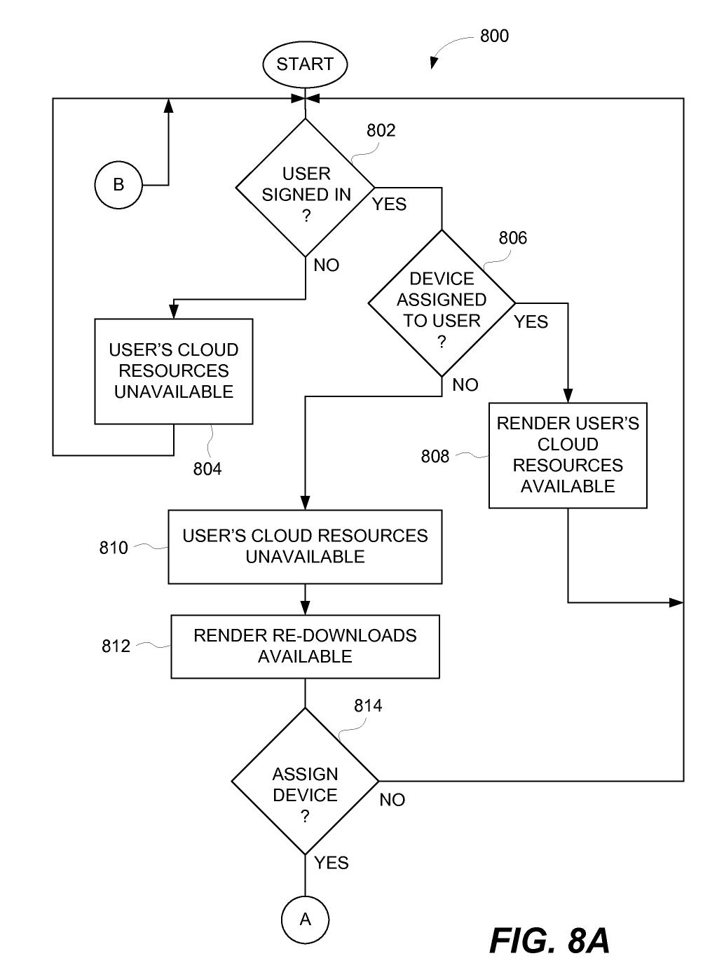

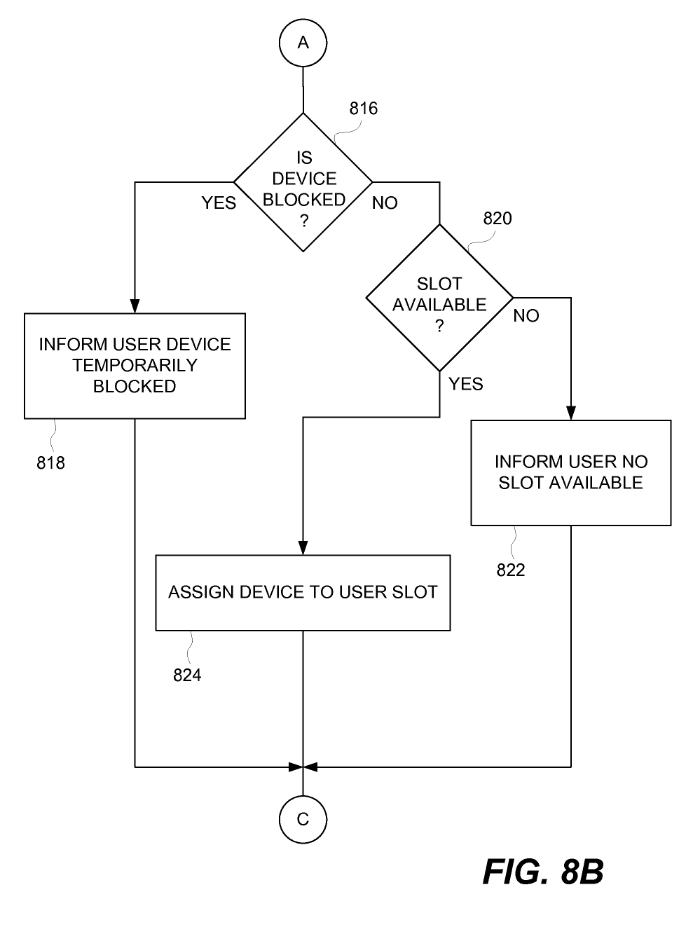

FIGS. 8A and 8B are flow diagrams of a cloud access process 800 according to one embodiment. The cloud access process 800 can be performed by a client device, such as a server computer that manages access or utilization of a cloud data repository.

The cloud access process 800 can begin with a decision 802 that determines whether a user of a particular client device has “signed in” to a cloud data repository manager. The “sign in” is, for example, a user login to a previously established user account with a user name and/or password. When the decision 802 determines that the user still has not signed in, the user is unable to gain access to the cloud data repository. Hence, the user's cloud resources are rendered 804 unavailable. Following block 804, the cloud access process 800 can return to repeat the decision 802 and subsequent blocks so that continuous monitoring of user status and device status for purposes of access to the cloud data repository can be ongoing.

On the other hand, when the decision 802 determines that the user has “signed in”, a decision 806 determines whether the particular client device has been assigned to the user. When the decision 806 determines that the particular client device has already been assigned to the user, the user's cloud resources are rendered 808 available to the user by way of the particular client device. Following the block 808, the cloud access process 800 can return to repeat the decision 802 and subsequent blocks so that continuous monitoring of the user status and device status for purposes of access to the cloud data repository can be ongoing.

Alternatively, when the decision 806 determines that the particular client device has not been assigned to the user, the user's cloud resources are rendered 810 unavailable. However, since the user is signed in, the cloud access process 800 may permit the user to utilize other non-cloud services. For example, as indicated in FIG. 8A, re-downloads can be rendered 812 available to the user (even to the particular client device). Here, although the user is not permitted to access the cloud data repository, the user is eligible to receive re-downloads of digital data that was previously acquired by the user. The availability of re-downloads can be limited to those digital assets that were previously purchased from an online digital asset store (e.g., an online digital asset store affiliated with the cloud data repository).

Next, decision 814 can determine whether the particular client device is to be assigned to the user. When the decision 814 determines that the particular client device is not to be assigned at this time, the cloud access process 800 can return to repeat the decision 802. Alternatively, when the decision 814 determines that the particular client device is to be assigned at this time, then additional processing can be performed to determine whether it is appropriate for the particular client device to be assigned to the user at this time.

The additional processing according to one embodiment is illustrated in FIG. 8B. In particular, a decision 816 can determine whether the particular client device is blocked. A particular client device can be blocked if that particular client device was recently assigned to another user. For example, a client device can be blocked from being assigned (i.e., re-assigned) for a predetermined period of time (e.g., 90 days). When the decision 816 determines that the particular client device is blocked from being assigned, the cloud access process 800 operates to inform 818 the user that the particular client device is temporarily blocked from being assigned. Alternatively, when the decision 816 determines that the particular client device is not blocked from being assigned, a decision 820 can determine whether there is an available slot to be assigned. When the decision 820 determines that there is no available slot, the user can be informed 822 that there is no slot available and thus the particular client device cannot be assigned at this time. In one implementation, the user may be provided with an opportunity to unassigned another device (that is currently assigned) to free up a slot that can be utilized for the particular client device. On the other hand, when the decision 820 determines that there is a slot available, the particular client device can be assigned 824 to the slot that is available. Following the blocks 818, 822 and 824, the cloud access process 800 can proceed to return to the decision 802 so that the cloud access process 800 can repeat and again evaluate whether to permit or deny user access to the cloud data repository by way of the particular client device.

In view of the foregoing, it will readily be known that an electronic device provided in accordance with one or more embodiments can, for example, be a computing device (e.g., personal computer), mobile phone (e.g., cellular phone, smart phone), personal digital assistant (PDA), media player (e.g., music, videos, games, images), media storage device, camera, and/or the like. An electronic device may also be a multi-functional device that combines two or more of these device functionalities into a single device. A portable electronic device may support various types of network communications.

A portable electronic device can be provided as a hand-held electronic device. The term hand-held can generally refer to an electronic device with a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Digital media assets (e.g., digital media items) can, for example pertain to video items (e.g., video files or movies), audio items (e.g., audio files or audio tracks, such as for songs, musical albums, podcasts or audiobooks), or image items (e.g., photos). The digital media assets can also include or be supplemented by text or multimedia files.

Additional information on digital asset delivery is provided in: (i) U.S. Provisional Patent Application No. 61/451,057, filed Mar. 9, 2011, entitled “INTELLIGENT DELIVERY AND ACQUISITION OF DIGITAL ASSETS,” which is herein incorporated by reference; and (ii) U.S. patent application Ser. No. 11/849,711, filed Sep. 4, 2007, and entitled “Digital Asset Delivery to Different Devices,” which is hereby incorporated herein by reference, and its corresponding U.S. Patent Publication 2009/0063301 A1 is also hereby incorporated herein by reference.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible (and non-transitory) and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of various embodiments of the invention are numerous. Different aspects, embodiments or implementations may, but need not, yield one or more of the following advantages. One advantage of at least some embodiments is that common digital assets can be shared across different users such that multiple uploads and storage of the same digital asset can be avoided. Another advantage of at least some embodiments is that limits on a user's devices that are able to access the user's cloud resources can be limited (or regulated) through use of assignable slots. Another advantage of at least some embodiments is that synchronization of a user's multiple client devices can be synchronized with respect to cloud storage and thus be synchronized across the user's multiple client devices.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for associating a client device to a remote data repository, the method comprising:
receiving an activation request from the client device seeking to associate with the remote data repository, the remote data repository providing remote data storage;
requesting hash values for artwork items on the client device;
determining whether any of the requested hash values match hash values of existing artwork items already maintained in the remote data repository; and
avoiding upload of those of the artwork items on the client device that have been determined to be already maintained in the remote data repository.

2. A method as recited in claim 1, wherein the client device is associated with a user account, and wherein the method comprises:
associating to the user account those of the artwork items on the client device that have been determined to be already maintained in the remote data repository.

3. A method as recited in claim 2, wherein the method comprises:
uploading to the remote data repository those of the artwork items on the client device that have been determined not to be already maintained in the remote data repository.

4. A method as recited in claim 3, wherein the method comprises:
associating to the user account those of the artwork items that have been uploaded in the remote data repository.

5. A method as recited in claim 1, wherein the method comprises:
uploading to the remote data repository those of the artwork items on the client device that have been determined not to be already maintained in the remote data repository.

6. A method as recited in claim 5, wherein the client device is associated with a user account, and wherein the method comprises:
associating to the user account those of the artwork items that have been uploaded in the remote data repository.

7. A method as recited in claim 1, wherein the method comprises:
determining whether any of a plurality of content items stored on the client device are already present in the remote data repository;
requesting upload of those of the content items stored on the client device that are not determined to already be present in the remote data repository;
receiving uploaded data from the client device that corresponds to the content items stored on the client device that are not determined to already be present in the remote data repository; and
adding the uploaded data to the remote data storage of the remote data repository.

8. A method as recited in claim 7, wherein the content items stored on the client device includes a plurality of local content items, and
wherein the determining comprises:
attempting to match an identifier for at least one of the local content items with an identifier for at least one remote content item already present at the remote data repository.

9. A method as recited in claim 8, wherein the determining comprises:
attempting to match a hash value for at least one of the local content items with a hash value for at least one remote content item already present at the remote data repository.

10. A method as recited in claim 9, wherein the determining comprises:
attempting to match a digital fingerprint for at least one of the local content items with a digital fingerprint for at least one remote content item already present at the remote data repository.

11. A method for associating a client device to a remote data repository, the method comprising:
receiving an activation request from the client device seeking to associate with the remote data repository, the remote data repository providing remote data storage;
requesting hash values for artwork items on the client device;
determining whether any of the requested hash values match hash values of existing artwork items already maintained in the remote data repository; and
avoiding upload of those of the artwork items on the client device that have been determined to be already maintained in the remote data repository.

12. A method for associating a client device to a remote data repository, the method comprising:
receiving an activation request from the client device seeking to associate with the remote data repository, the remote data repository providing remote data storage for a plurality of digital media assets;
determining whether any local digital media assets stored on the client device are already present in the remote data repository, wherein the stored data for each of the local digital media assets includes at least a content item and an artwork item, and wherein the determining separately determines whether the content item and the artwork item for each of the local digital media assets are already present at the remote data repository; and
requesting upload of data from the client device, the requested data to be uploaded including: (i) the one or more content items on the client device that are not determined to already be present in the remote data repository, and (ii) the one or more artwork items on the client device that are not determined to already be present in the remote data repository.

13. A method as recited in claim 12, wherein the method comprises:
receiving upload of the requested data from the client device that corresponds to the local digital media assets on the client device that are not determined to already be present in the remote data repository; and
adding the uploaded data to the remote data storage of the remote data repository.

14. A method as recited in claim 12, wherein the determining comprises:
requesting hash values for the artwork item on the client device for each of the local digital media assets;
determining whether any of the requested hash values match hash values of existing artwork items already maintained in the remote data repository; and
concluding that certain of the artwork items on the client device for each of the local digital media assets are already maintained in the remote data repository if it is determined that the requested hash values match corresponding hash values of existing artwork items already maintained in the remote data repository.

15. A method as recited in claim 12,
wherein the stored data for each of the local digital media assets further includes a metadata item, and
wherein the determining separately determines whether the content item, the metadata item and the artwork item for each of the local digital media assets are already present at the remote data repository, and
wherein the requesting upload comprises:
requesting upload of data from the client device of the one or more metadata items on the client device that are not determined to already be present in the remote data repository.

16. A method as recited in claim 15, wherein the determining comprises:
requesting hash values for the artwork item on the client device for each of the local digital media assets;
determining whether any of the requested hash values match hash values of existing artwork items already maintained in the remote data repository; and
concluding that certain of the artwork items on the client device for each of the local digital media assets are already maintained in the remote data repository if it is determined that the requested hash values match corresponding hash values of existing artwork items already maintained in the remote data repository.

17. A non-transitory computer readable medium including at least computer program code stored thereon for associating a client device to a remote data repository, the non-transitory computer readable medium comprising:
computer program code for receiving an activation request from the client device seeking to associate with the remote data repository, the remote data repository providing remote data storage;
computer program code for requesting hash values for artwork items on the client device;
computer program code for determining whether any of the requested hash values match hash values of existing artwork items already maintained in the remote data repository; and
computer program code for avoiding upload of those of the artwork items on the client device that have been determined to be already maintained in the remote data repository.

18. A non-transitory computer readable medium including at least computer program code stored thereon for associating a client device to a remote data repository, the non-transitory computer readable medium comprising:
computer program code for receiving an activation request from the client device seeking to associate with the remote data repository, the remote data repository providing remote data storage for a plurality of digital media assets;
computer program code for determining whether any local digital media assets stored on the client device are already present in the remote data repository, wherein the stored data for each of the local digital media assets includes at least a content item and an artwork item, and wherein the computer program code for determining separately determines whether the content item and the artwork item for each of the local digital media assets are already present at the remote data repository; and
computer program code for requesting upload of data from the client device, the requested data to be uploaded including: (i) the one or more content items on the client device that are not determined to already be present in the remote data repository, and (ii) the one or more artwork items on the client device that are not determined to already be present in the remote data repository.

19. A non-transitory computer readable medium as recited in claim 18, wherein the non-transitory computer readable medium comprises:
computer program code for receiving upload of the requested data from the client device that corresponds to the local digital media assets on the client device that are not determined to already be present in the remote data repository; and
computer program code for adding the uploaded data to the remote data storage of the remote data repository.

20. A non-transitory computer readable medium as recited in claim 18, wherein the determining comprises:
computer program code for requesting hash values for the artwork item on the client device for each of the local digital media assets;
computer program code for determining whether any of the requested hash values match hash values of existing artwork items already maintained in the remote data repository; and
computer program code for concluding that certain of the artwork items on the client device for each of the local digital media assets are already maintained in the remote data repository if it is determined that the requested hash values match corresponding hash values of existing artwork items already maintained in the remote data repository.

21. A non-transitory computer readable medium as recited in claim 18,
wherein the stored data for each of the local digital media assets further includes a metadata item, and
wherein the computer program code for determining separately determines whether the content item, the metadata item and the artwork item for each of the local digital media assets are already present at the remote data repository, and
wherein the computer program code for requesting upload comprises:
computer program code for requesting upload of data from the client device of the one or more metadata items on the client device that are not determined to already be present in the remote data repository.

22. A non-transitory computer readable medium as recited in claim 21, wherein the computer program code for determining comprises:
computer program code for requesting hash values for the artwork item on the client device for each of the local digital media assets;
computer program code for determining whether any of the requested hash values match hash values of existing artwork items already maintained in the remote data repository; and
computer program code for concluding that certain of the artwork items on the client device for each of the local digital media assets are already maintained in the remote data repository if it is determined that the requested hash values match corresponding hash values of existing artwork items already maintained in the remote data repository.

23. A system for providing a network-based repository accessible by client devices via a network, the system comprising:
cloud storage configured to store digital data for a plurality of account holders, the cloud storage being accessible by authorized client devices via the network; and
at least one cloud server operatively connected to the cloud storage, the at least one cloud server being configured to:
receive an activation request from a client device seeking to associate with the network-based repository, the networked-based repository providing remote data storage for a plurality of digital media assets;
determine whether any local digital media assets stored on the client device are already present in the network-based data repository, wherein the stored data for each of the local digital media assets includes at least a content item and an artwork item, and wherein the determining separately determines whether the content item and the artwork item for each of the local digital media assets are already present at the network-based repository; and
request upload of data from the client device, the requested data to be uploaded including: (i) the one or more content items on the client device that are not determined to already be present in the network-based repository, and (ii) the one or more artwork items on the client device that are not determined to already be present in the network-based repository.
